(19) United States
(12) Patent Application Publication
(10) Pub. No.: US 2020/0012999 A1
(43) Pub. Date: Jan. 9, 2020

(54) METHOD AND APPARATUS FOR INFORMATION PROCESSING

(71) Applicant: Baidu USA LLC, Sunnyvale, CA (US)

(72) Inventors: Le Kang, Mountain View, CA (US); Yingze Bao, Beijing (CN); Mingyu Chen, Santa Clara, CA (US)

(21) Appl. No.: 16/026,699

(22) Filed: Jul. 3, 2018

(51) Int. Cl. G06Q 10/08; G06Q 30/06; G06K 9/00

(52) U.S. Cl. CPC G06Q 10/087; G06Q 30/0623; G06K 9/00375; G06K 9/00624; G06K 9/00369; G06Q 30/0639

(57) ABSTRACT

A method and an apparatus for information processing. A preferred embodiment of the method includes: determining whether a quantity of an item stored in an unmanned store changes; updating a user state information table based on item change information of the item stored in the unmanned store and user behavior information of a user in the unmanned store in response to determining that the quantity of the item stored in the unmanned store changes; determining whether the user in the unmanned store has an item passing behavior; and updating the user state information table based on the user behavior information of the user in the unmanned store in response to determining that the user in the unmanned store has the item passing behavior. This embodiment reduces the times of updating the user state information table, and further saves computational resources.

### TECHNICAL FIELD

Embodiments of the present disclosure relate to the field of computer technologies, and more particularly relate to a method and an apparatus for information processing.

### BACKGROUND

An unmanned store, also referred to as “self-service store,” is a store where no attendants serve customers and the customers may independently complete item choosing and payment.

In the unmanned store, it is required to constantly track where a customer is located and what items are chosen by the customers, which needs to occupy more computational resources.

### SUMMARY

Embodiments of the present disclosure provide a method and an apparatus for information processing.

In a first aspect, an embodiment of the present disclosure provides a method for information processing, the method comprising: determining whether a quantity of an item stored in an unmanned store changes; updating a user state information table based on item change information of the item stored in the unmanned store and user behavior information of a user in the unmanned store in response to determining that the quantity of the item stored in the unmanned store changes; determining whether the user in the unmanned store has an item passing behavior; and updating the user state information table based on the user behavior information of the user in the unmanned store in response to determining that the user in the unmanned store has the item passing behavior.

In some embodiments, the method further comprises: generating user state information based on a user identifier and user position information of the user entering the unmanned store in response to detecting that the user enters the unmanned store, and adding the generated user state information to the user state information table.

In some embodiments, the method further comprises: deleting user state information corresponding to the user leaving the unmanned store from the user state information table in response to detecting that the user leaves the unmanned store.

In some embodiments, at least one of the following is provided in the unmanned store: a shelf product detection & recognition camera, a human tracking camera, a human action recognition camera, a ceiling product detection & recognition camera, and a gravity sensor.

In some embodiments, the user state information includes the user identifier, the user position information, a set of user behavior information, and a set of chosen item information, wherein the user behavior information includes a behavior identifier and a user behavior probability value, and the chosen item information includes an item identifier, the quantity of the chosen item, and a probability value of choosing the item, and wherein the step of generating user state information based on a user identifier and user position information of the user entering the unmanned store comprises: determining the user identifier and the user position information of the user entering the unmanned store, wherein the determined user identifier and user position information are obtained based on data outputted by the human tracking camera; and generating new user state information based on the determined user identifier and user position information, an empty set of user behavior information, and an empty set of chosen item information.

In some embodiments, the item change information includes an item identifier, a change in the quantity of the item, and a quantity change probability value, and wherein the step of determining whether the quantity of the item stored in an unmanned store changes comprises: acquiring item change information of respective item stored in the unmanned store, wherein the item change information is obtained based on at least one of: data outputted by the shelf product detection & recognition camera, and data outputted by the gravity sensor; determining that the quantity of the item stored in the unmanned store changes in response to determining that the item change information with a quantity change probability value being greater than a first preset probability value exists in the acquired item change information; and determining that the quantity of the item stored in the unmanned store does not change in response to determining that item change information with the quantity change probability value being greater than a first preset probability value does not exist in the acquired item change information.

In some embodiments, the step of determining whether the user in the unmanned store has an item passing behavior comprises: acquiring user behavior information of respective user in the unmanned store, wherein the user behavior information is obtained based on data outputted by the human action recognition camera; determining that the user in the unmanned store has the item passing behavior in response to presence of user behavior information with a behavior identifier for characterizing passing of the item and a user behavior probability value being greater than a second preset probability value in the acquired user behavior information; and determining that the user in the unmanned store does not have an item passing behavior in response to absence of the user behavior information with the behavior identifier for characterizing passing of the item and the user behavior probability value being greater than the second preset probability value in the acquired user behavior information.

In some embodiments, a light curtain sensor is provided in front of a shelf in the unmanned store; and the user behavior information is obtained based on at least one of: data outputted by the human action recognition camera and data outputted by the light curtain sensor disposed in front of the shelf in the unmanned store.

In some embodiments, the user position information includes at least one of: user left hand position information, user right hand position information, and user chest position information.

In some embodiments, at least one of a light curtain sensor and an auto gate is provided at an entrance of the unmanned store, and wherein the step of detecting that the user enters the unmanned store comprises: determining that the user's entering the unmanned store is detected in response to determining that at least one of the light curtain sensor and the auto gate at the entrance of the unmanned store detects that the user passes; or determining that the user's entering the unmanned store is detected in response to determining that the human tracking camera detects that the user enters the unmanned store.

In some embodiments, at least one of the light curtain sensor and an auto gate is provided at an exit of the unmanned store, and wherein the step of detecting that the user leaves the unmanned store comprises: determining that the user's leaving the unmanned store is detected in response to determining that at least one of the light curtain sensor and the auto gate at the exit of the unmanned store detects that the user passes; or determining that the user's leaving the unmanned store is detected in response to determining that the human tracking camera detects that the user leaves the unmanned store.

In some embodiments, the step of updating a user state information table based on the item change information of the item stored in the unmanned store and the user behavior information of the user in the unmanned store comprises: for each target item whose quantity changes in the unmanned store and for each target user whose distance from the target item is smaller than a first preset distance threshold among users in the unmanned store, calculating a probability value of the target user's choosing the target item based on a probability value of quantity decrease of the target item, the distance between the target user and the target item, and a probability of the target user's grabbing the item, and adding first target chosen item information to the set of chosen item information of the target user in the user state information table, wherein the first target chosen item information is generated based on an item identifier of the target item and a calculated probability value of the target user's choosing the target item.

In some embodiments, the step of calculating a probability value of the target user's choosing the target item based on a probability value of quantity decrease of the target item, the distance between the target user and the target item, and a probability of the target user's grabbing the item comprises: calculating the probability value of the target user's choosing the target item according to an equation below:

$$P ( A got c ) = P ( c missing ) \frac{P ( A near c ) P ( A grab )}{{\sum }_{k ∈ K} P ( k near c ) P ( k grab )}$$

where c denotes the item identifier of the target item, A denotes the user identifier of the target user, K denotes a set of user identifiers of respective target users whose distances from the target item are smaller than the first preset distance threshold, k denotes any user identifier in K, P(c missing) denotes a probability value of quantity decrease of the target item calculated based on the data acquired by the shelf product detection & recognition camera, P(A near c) denotes a near degree value between the target user and the target item, P(A near c) is negatively correlated with the distance between the target user and the target item, P(A grab) denotes a probability value of the target user's grabbing the item calculated based on the data acquired by the human action recognition camera, P(k near c) denotes a near degree value between the user indicated by the user identifier k and the target item, P(k near c) is negatively correlated to the distance between the user indicated by the user identifier k and the target item, P(k grab) denotes a probability value of the user indicated by the user identifier k for grabbing the item as calculated based on the data acquired by the human action recognition camera, and P(A got c) denotes a calculated probability value of the target user's choosing the target item.

In some embodiments, the step of updating the user state information table based on the user behavior information of the user in the unmanned store in response to determining that the user in the unmanned store has an item passing behavior further comprises: in response to determining that the user in the unmanned store has an item passing behavior, wherein a first user passes the item to a second user, calculating a probability value of the first user's choosing the passed item and a probability value of the second user's choosing the passed item based on a probability value of the first user's passing the item to the second user and a probability value of presence of the passed item in an area where the first user passes the item to the second user, respectively, and adding second target chosen item information to the set of chosen item information of the first user in the user state information table, and adding a third target chosen item information to the set of chosen item information of the second user in the user state information table, wherein the second target chosen item information is generated based on an item identifier of the passed item and a calculated probability value of the first user's choosing the passed item, and the third target chosen item information is generated based on the item identifier of the passed item and a calculated probability value of the second user's choosing the passed item.

In some embodiments, the step of calculating a probability value of the first user's choosing the passed item and a probability value of the second user's choosing the passed item based on a probability value of the first user's passing the item to the second user and a probability value of presence of the passed item in an area where the first user passes the item to the second user, respectively, comprises: calculating the probability value of the first user's choosing the passed item and the probability value of the second user's choosing the passed item according to an equation below, respectively:

P(B got d)=P(A pass B)P(d)

P(A got d)=1−P(B got d)

where d denotes the item identifier of the passed item, A denotes the user identifier of the first user, B denotes the user identifier of the second user, P(A pass B) denotes the probability value of the first user's passing the item to the second user calculated based on the data acquired by the human action recognition camera, P(d) denotes a probability value of presence of the item indicated by the item identifier d in the area where the first user passes the item to the second user, calculated based on the data acquired by the ceiling product detection & recognition camera, while P(B got d) is a calculated probability value of the second user's choosing the passed item, and P(A got d) denotes a calculated probability value of the first user's choosing the passed item.

In a second aspect, an embodiment of the present disclosure provides an apparatus for information processing, the apparatus comprising: a first determining unit configured for determining whether a quantity of an item stored in an unmanned store changes; a first updating unit configured for updating a user state information table based on item change information of the item stored in the unmanned store and user behavior information of a user in the unmanned store in response to determining that the quantity of the item stored in the unmanned store changes; a second determining unit configured for determining whether the user in the unmanned store has an item passing behavior; and a second updating unit configured for updating the user state information table based on the user behavior information of the user in the unmanned store in response to determining that the user in the unmanned store has the item passing behavior.

In some embodiments, the apparatus further comprises: an information adding unit configured for generating user state information based on a user identifier and user position information of the user entering the unmanned store in response to detecting that the user enters the unmanned store, and adding the generated user state information to the user state information table.

In some embodiments, the apparatus further comprises: an information deleting unit configured for deleting user state information corresponding to the user leaving the unmanned store from the user state information table in response to detecting that the user leaves the unmanned store.

In some embodiments, at least one of the following is provided in the unmanned store: a shelf product detection & recognition camera, a human tracking camera, a human action recognition camera, a ceiling product detection & recognition camera, and a gravity sensor.

In some embodiments, the user state information includes a user identifier, user position information, a set of user behavior information, and a set of chosen item information, wherein the user behavior information includes a behavior identifier and a user behavior probability value, and the chosen item information includes an item identifier, the quantity of the chosen item, and a probability value of choosing the item, and the information adding unit is further configured for: determining the user identifier and the user position information of the user entering the unmanned store, wherein the determined user identifier and user position information are obtained based on data outputted by the human tracking camera; and generating new user state information based on the determined user identifier and user position information, an empty set of user behavior information, and an empty set of chosen item information.

In some embodiments, the item change information includes an item identifier, a change in the quantity of the item, and a quantity change probability value, and the first determining unit includes: an item change information acquiring module configured for acquiring item change information of respective item stored in the unmanned store, wherein the item change information is obtained based on at least one of: data outputted by the shelf product detection & recognition camera and data outputted by the gravity sensor; a first determining module configured for determining that the quantity of the item stored in the unmanned store changes in response to determining that item change information with a quantity change probability value being greater than a first preset probability value exists in the acquired item change information; and a second determining module configured for determining that the quantity of the item stored in the unmanned store does not change in response to determining that item change information with the quantity change probability value being greater than a first preset probability value does not exist in the acquired item change information.

In some embodiments, the second determining unit comprises: a user behavior information acquiring module configured for acquiring user behavior information of respective user in the unmanned store, wherein the user behavior information is obtained based on data outputted by the human action recognition camera; a third determining module configured for determining that the user in the unmanned store has the item passing behavior in response to presence of user behavior information with a behavior identifier for characterizing passing of the item and a user behavior probability value being greater than a second preset probability value in the acquired user behavior information; and a fourth determining module configured for determining that the user in the unmanned store does not have an item passing behavior in response to absence of the user behavior information with the behavior identifier for characterizing passing of the item and the user behavior probability value being greater than the second preset probability value in the acquired user behavior information.

In some embodiments, a light curtain sensor is provided in front of a shelf in the unmanned store; and the user behavior information is obtained based on at least one of: data outputted by the human action recognition camera and data outputted by the light curtain sensor disposed in front of the shelf in the unmanned store.

In some embodiments, the user position information includes at least one of: user left hand position information, user right hand position information, and user chest position information.

In some embodiments, at least one of a light curtain sensor and an auto gate is provided at an entrance of the unmanned store, and the information adding unit is further configured for determining that the user's entering the unmanned store is detected in response to determining that at least one of the light curtain sensor and the auto gate at the entrance of the unmanned store detects that the user passes; or determining that the user's entering the unmanned store is detected in response to determining that the human tracking camera detects that the user enters the unmanned store.

In some embodiments, at least one of the light curtain sensor and an auto gate is provided at an exit of the unmanned store, and the information deleting unit is further configured for: determining that the user's leaving the unmanned store is detected in response to determining that at least one of the light curtain sensor and the auto gate at the exit of the unmanned store detects that the user passes; or determining that the user's leaving the unmanned store is detected in response to determining that the human tracking camera detects that the user leaves the unmanned store.

In some embodiments, the first updating unit is further configured for: for each target item whose quantity changes in the unmanned store and for each target user whose distance from the target item is smaller than a first preset distance threshold among users in the unmanned store, calculating a probability value of the target user's choosing the target item based on a probability value of quantity decrease of the target item, the distance between the target user and the target item, and a probability of the target user's grabbing the item, and adding first target chosen item information to the set of chosen item information of the target user in the user state information table, wherein the first target chosen item information is generated based on an item identifier of the target item and a calculated probability value of the target user's choosing the target item.

In some embodiments, the step of calculating a probability value of the target user's choosing the target item based on a probability value of quantity decrease of the target item, the distance between the target user and the target item, and a probability of the target user's grabbing the item comprises: calculating the probability value of the target user's choosing the target item according to an equation below:

$$P ( A got c ) = P ( c missing ) \frac{P ( A near c ) P ( A grab )}{{\sum }_{k ∈ K} P ( k near c ) P ( k grab )}$$

where c denotes the item identifier of the target item, A denotes the user identifier of the target user, K denotes a set of user identifiers of respective target users whose distances from the target item are smaller than the first preset distance threshold, k denotes any user identifier in K, P(c missing) denotes a probability value of quantity decrease of the target item calculated based on the data acquired by the shelf product detection & recognition camera, P(A near c) denotes a near degree value between the target user and the target item, P(A near c) is negatively correlated with the distance between the target user and the target item, P(A grab) denotes a probability value of the target user's grabbing the item calculated based on the data acquired by the human action recognition camera, P(k near c) denotes a near degree value between the user indicated by the user identifier k and the target item, P(k near c) is negatively correlated to the distance between the user indicated by the user identifier k and the target item, P(k grab) denotes a probability value of the user indicated by the user identifier k for grabbing the item as calculated based on the data acquired by the human action recognition camera, and P(A got c) denotes a calculated probability value of the target user's choosing the target item.

In some embodiments, the second updating unit is further configured for: in response to determining that the user in the unmanned store has an item passing behavior, wherein a first user passes the item to a second user, calculating a probability value of the first user's choosing the passed item and a probability value of the second user's choosing the passed item based on a probability value of the first user's passing the item to the second user and a probability value of presence of the passed item in an area where the first user passes the item to the second user, respectively, and adding second target chosen item information to the set of chosen item information of the first user in the user state information table, and adding a third target chosen item information to the set of chosen item information of the second user in the user state information table, wherein the second target chosen item information is generated based on an item identifier of the passed item and a calculated probability value of the first user's choosing the passed item, and the third target chosen item information is generated based on the item identifier of the passed item and a calculated probability value of the second user's choosing the passed item.

In some embodiments, the step of calculating a probability value of the first user's choosing the passed item and a probability value of the second user's choosing the passed item based on a probability value of the first user's passing the item to the second user and a probability value of presence of the passed item in an area where the first user passes the item to the second user, respectively, comprises: calculating the probability value of the first user's choosing the passed item and the probability value of the second user's choosing the passed item according to an equation below, respectively:

P(B got d)=P(A pass B)P(d)

P(A got d)=1−P(B got d)

where d denotes the item identifier of the passed item, A denotes the user identifier of the first user, B denotes the user identifier of the second user, P(A pass B) denotes the probability value of the first user's passing the item to the second user calculated based on the data acquired by the human action recognition camera, P(d) denotes a probability value of presence of the item indicated by the item identifier d in the area where the first user passes the item to the second user, calculated based on the data acquired by the ceiling product detection & recognition camera, while P(B got d) is a calculated probability value of the second user's choosing the passed item, and P(A got d) denotes a calculated probability value of the first user's choosing the passed item.

In a third aspect, an embodiment of the present disclosure provides a server, the server comprising: an interface; a memory on which one or more programs are stored; and one or more processors operably coupled to the interface and the memory, wherein the one or more processors function to: determine whether a quantity of an item stored in an unmanned store changes; update a user state information table based on item change information of the item stored in the unmanned store and user behavior information of a user in the unmanned store in response to determining that the quantity of the item stored in the unmanned store changes; determine whether the user in the unmanned store has an item passing behavior; and update the user state information table based on the user behavior information of the user in the unmanned store in response to determining that the user in the unmanned store has the item passing behavior.

In a fourth aspect, an embodiment of the present disclosure provides a computer-readable medium on which a program is stored, wherein the program, when being executed by one or more processors, causes the one or more processors to: determine whether a quantity of an item stored in an unmanned store changes; update a user state information table based on item change information of the item stored in the unmanned store and user behavior information of a user in the unmanned store in response to determining that the quantity of the item stored in the unmanned store changes; determine whether the user in the unmanned store has an item passing behavior; and update the user state information table based on the user behavior information of the user in the unmanned store in response to determining that the user in the unmanned store has the item passing behavior.

The method and apparatus for information processing provided by the embodiments of the present disclosure reduces the times of updating the user state information table and then saves computational resources by updating, when detecting a change in the quantity of an item stored in the unmanned store, the user state information table of the unmanned store based on the item change information of the item stored in the unmanned store and the user behavior information of a user in the unmanned store; or by updating, when detecting that the user in the unmanned store has an item passing behavior, the user state information table based on the user behavior information of the user in the unmanned store.

### BRIEF DESCRIPTION OF THE DRAWINGS

Other features, objectives and advantages of the present disclosure will become more apparent through reading the detailed description of non-limiting embodiments with reference to the accompanying drawings.

FIG. 1 is an exemplary system architecture diagram in which an embodiment of the present disclosure may be applied;

FIG. 2 is a flow chart of an embodiment of a method for information processing according to the present disclosure;

FIG. 3 is a flow chart of another embodiment of the method for information processing according to the present disclosure;

FIG. 4 is a schematic diagram of an application scenario of the method for information processing according to the present disclosure;

FIG. 5 is a structural schematic diagram of an embodiment of an apparatus for information processing according to the present disclosure; and

FIG. 6 is a structural schematic diagram of a computer system of a server adapted for implementing the embodiments of the present disclosure.

### DETAILED DESCRIPTION OF THE PREFERRED EMBODIMENTS

Hereinafter, the present disclosure will be described in further detail with reference to the accompanying drawings and the embodiments. It will be appreciated that the preferred embodiments described herein are only for illustration, rather than limiting the present disclosure. In addition, it should also be noted that for the ease of description, the drawings only illustrate those parts related to the present disclosure.

It needs to be noted that without conflicts, the embodiments in the present disclosure and the features in the embodiments may be combined with each other. Hereinafter, the present disclosure will be illustrated in detail with reference to the accompanying drawings in conjunction with the embodiments.

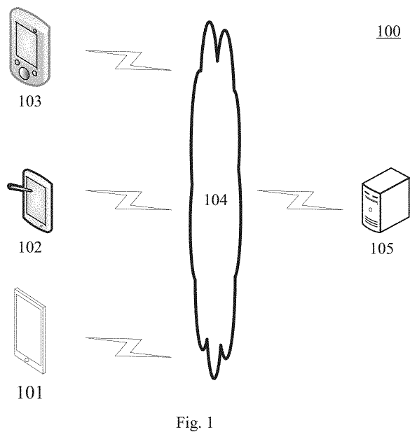

FIG. 1 illustrates an exemplary system architecture 100 that may apply embodiments of a method for information processing or an apparatus for information processing according to the present disclosure.

As shown in FIG. 1, the system architecture 100 may comprise terminal devices 101, 102, 103, a network 104 and a server 105. The network 104 is configured as a medium for providing a communication link between the terminal devices 101, 102, 103, and the server 105. The network 104 may comprise various connection types, e.g., a wired/wireless communication link or an optical fiber cable, etc.

A user may interact with the server 105 via the network 104 using the terminal devices 101, 102, 103 to receive or send messages, etc. The terminal devices 101, 102, and 103 may be installed with various kinds of communication client applications, e.g., payment applications, shopping applications, web browser applications, search applications, instant messaging tools, mail clients, and social platform software, etc.

The terminals 101, 102, 103 may be hardware or software. When the terminal devices 101, 102, 103 are hardware, they may be various kinds of mobile electronic devices having a display screen, including, but not limited to, a smart mobile phone, a tablet computer, and a laptop portable computer, etc. When the terminal devices 101, 102, and 103 are software, they may be installed in the electronic devices listed above. The terminal devices may also be implemented as a plurality of software or software modules (e.g., for providing payment services) or implemented as a single piece of software or software module, which is not specifically limited here.

The server 105 may be a server that provides various services, e.g., a background server that provides support for payment applications displayed on the terminal devices 101, 102, and 103. The background server may process (such as analyze) data such as the received payment request, and feed the processing result (e.g., a payment success message) back to the terminal device.

It needs to be noted that the method for information processing provided by the embodiments of the present disclosure is generally executed by the server 105, and correspondingly, the apparatus for information processing is generally arranged in the server 105.

It needs to be noted that a user may alternatively not use a terminal device to pay chosen items in the unmanned store; instead, he/she may adopt other payment means, e.g., by cash or by card; and in these cases, the exemplary system architecture 100 may alternatively not include the terminal devices 101, 102, 103 or the network 104.

It needs to be noted that the server 105 may be hardware or software. When the server 105 is hardware, it may be implemented as a distributed server cluster combined by a plurality of servers or may be implemented as a single server. When the server 105 is software, it may be implemented as a plurality of pieces of software or software modules (e.g., for payment services) or implemented as a single piece of software or software module, which is not specifically limited here.

It may be understood that various data acquisition devices may be provided in the unmanned store. For example, cameras, gravity sensors, and various kinds of scanning devices, etc. Among them, the cameras may acquire an image of an item and an image of a user to further identify the item or the user. The scanning devices may scan a bar code or a two-dimensional code printed on an item package to obtain a price of the item; the scanning devices may also scan a two-dimensional code displayed on a user portable terminal device to obtain user identity information or user payment information. For example, the scanning devices may include, but not limited to, any one of the following: a bar code scanning device, a two-dimensional scanning device, and an RFID (Radio Frequency Identification) scanning device.

In some optional implementations, a sensing gate may be provided at an entrance and/or an exit of the unmanned store.

Moreover, the various devices above may be connected via the server 105, such that the data acquired by the various devices may be transmitted to the server 105, or the server 105 may transmit data or instructions to the various devices above.

It should be understood that the numbers of the terminal devices, the networks and the servers in FIG. 1 are only schematic. Any numbers of terminals, networks and servers may be provided according to implementation needs.

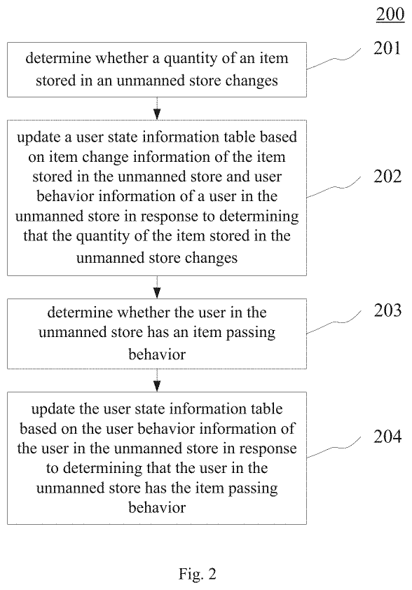

Continue to refer to FIG. 2, which shows a flow 200 of an embodiment of a method for information processing according to the present disclosure. The method for information processing comprises steps of:

Step 201: determining whether a quantity of an item stored in an unmanned store changes.

In this embodiment, at least one kind of item may be stored in the unmanned store, and there may be at least one piece for each kind of item. In this way, an executing body (e.g., the server in FIG. 1) of the method for information processing may adopt different implementations based on different data acquisition devices provided in the unmanned store to determine whether the quantity of the item stored in the unmanned store changes.

In some optional implementations of this embodiment, at least one shelf product detection & recognition camera may be provided in the unmanned store, and shooting ranges of respective shelf product detection & recognition cameras may cover respective shelves in the unmanned store. In this way, the executing body may receive, in real time, each video frame acquired by the at least one shelf product detection & recognition camera and determine whether the quantity of the item on the shelf covered by the shelf product detection & recognition camera increases or decreases based on a video frame acquired by each shelf product detection & recognition camera in a first preset time length counted backward from the current moment. In the case that there exists a camera among the at least one shelf product detection & recognition camera where the quantity of an item on a shelf covered thereby increases or decreases, it may be determined that the quantity of the item stored in the unmanned store changes. Otherwise, in the case that there exists no camera among the at least one shelf product detection & recognition camera where the quantity of the item on a shelf covered thereby increases or decreases, it may be determined that the quantity of the item stored in the unmanned store does not change.

In some optional implementations of this embodiment, at least one gravity sensor may be provided in the unmanned store; moreover, items in the unmanned store are disposed on the gravity sensor. In this way, the executing body may receive in real time gravity values transmitted by respective gravity sensors of the unmanned store, and based on a difference between a gravity value acquired at the current moment and a gravity value acquired before the current moment by each gravity sensor, determine whether the quantity of the item corresponding to the gravity sensor increases or decreases. In the case that there exists a gravity sensor among the at least one gravity sensor where the quantity of the item corresponding thereto increases or decreases, it may be determined that the quantity of the item stored in the unmanned store changes. Otherwise, in the case that no gravity sensor among the at least one gravity sensor exists where the quantity of the item corresponding thereto increases or decreases, it may be determined that the quantity of the item stored in the unmanned store does not change.

In some optional implementations of the present disclosure, a shelf product detection & recognition camera and a gravity sensor may be both disposed in the unmanned store; in this way, the executing body may receive in real time the data acquired by the shelf product detection & recognition camera and the data acquired by the gravity sensor, determine, based on the video frame acquired by each shelf product detection & recognition camera in the first preset time length dated from the current moment, whether the quantity of the item on a shelf covered by the shelf product detection & recognition camera increases or decreases, and determine, based on a difference between a gravity value acquired at the current moment and a gravity value acquired before the current moment by the each gravity sensor, whether the quantity of item corresponding to the gravity sensor increases or decreases. In the case that the item corresponding to the gravity sensor is on the shelf covered by one shelf product detection & recognition camera and it has been determined that the quantity of the item corresponding to the gravity sensor increases and the quantity of the item on the shelf covered by the shelf product detection & recognition camera also increases, it may be determined that the quantity of the item stored in the unmanned store changes. In the case that the item corresponding to the gravity sensor is on the shelf covered by one shelf product detection & recognition camera and it has been determined that the quantity of the item corresponding to the gravity sensor decreases and the quantity of the item on the shelf covered by the shelf product detection & recognition camera also decreases, it may be determined that the quantity of the item stored in the unmanned store changes. In the case that the item corresponding to the gravity sensor is on the shelf covered by one shelf product detection & recognition camera and it has been determined that the quantity of the item corresponding to the gravity sensor increases while the quantity of the item on the shelf covered by the shelf product detection & recognition camera decreases, it may be determined that the quantity of the item stored in the unmanned store does not change. In the case that the item corresponding to the gravity sensor is on the shelf covered by one shelf product detection & recognition camera and it has been determined that the quantity of the item corresponding to the gravity sensor decreases while the quantity of the item on the shelf covered by the shelf product detection & recognition camera increases, it may be determined that the quantity of the item stored in the unmanned store does not change.

In some optional implementations of this embodiment, at least one shelf product detection & recognition camera and at least one gravity sensor may be both provided in the unmanned store, wherein the shooting ranges of respective shelf product detection & recognition cameras may cover respective shelves in the unmanned store, and the items in the unmanned store are disposed on the gravity sensors. In this way, the step 201 may also be performed as follows:

First, item change information of the respective item stored in the unmanned store may be acquired.

wherein the item change information of the respective item stored in the unmanned store is obtained based on at least one of: data outputted by the shelf product detection & recognition camera, and data outputted by the gravity sensor. The item change information includes: an item identifier, an item quantity change, and a quantity change probability value, wherein the quantity change probability value in the item change information is for characterizing the probability of the quantity change of the item indicated by the item identifier being the item quantity change.

For example, first item change information may be obtained based on the data outputted by the shelf product detection & recognition camera, and second item change information may be obtained based on data outputted by the gravity sensor. For each item stored in the unmanned store, the first item change information corresponding to the item may serve as the item change information for the item; the second item change information corresponding to the item may also serve as the item change information of the item; the item quantity change and the quantity change probability value in the first item change information and the second item change information corresponding to the item may be weight-summed based on a preset first weight and a preset second weight, and the weight-summed item change information serves as the item change information of the item.

Then, it may be determined whether the acquired item change information includes item change information where the quantity change probability value is greater than a first preset probability value. If yes, it may be determined that the quantity of the item stored in the unmanned store changes. If not, it may be determined that the quantity of the item stored in the unmanned store does not change.

Step 202: updating a user state information table based on item change information of the item stored in the unmanned store and user behavior information of a user in the unmanned store in response to determining that the quantity of the item stored in the unmanned store changes.

In this embodiment, when it is determined in step 201 that the quantity of the item stored in the unmanned store changes, the executing body (e.g., the server shown in FIG. 1) may first acquire the item change information of the item stored in the unmanned store and the user behavior information of the user in the unmanned store, and then update the user state information table of the unmanned store based on the obtained item change information and user behavior information in various implementations.

In this embodiment, the item change information of the item stored in the unmanned store may be obtained after the executing body analyzes and processes the data acquired by the various data acquiring devices provided in the unmanned store. The details may refer to relevant description in step 201, which will not be detailed here.

Here, the item change information is for characterizing the quantity change detail of the item stored in the unmanned store.

In some optional implementations of this embodiment, the item change information may include the item identifier and an increase mark (e.g., positive mark “+”) for characterizing increase of the quantity or a decrease mark (e.g., negative mark “−”) for characterizing decrease of the quantity. Here, when the item change information includes the increase mark, the item change information is for characterizing that the quantity of the item indicated by the item identifier increases. When the item change information includes the decrease mark, the item change information is for characterizing that the quantity of the item indicated by the item identifier decreases.

Here, item identifiers are for uniquely identifying various items stored in the unmanned store. For example, the item identifier may be a character string combined by digits, letters and symbols, and the item identifier may also be a bar code or a two-dimensional code.

In some optional implementations of this embodiment, the item change information may also include the item identifier and the item quantity change; wherein the item quantity change is a positive integer or a negative integer. When the item quantity change in the item change information is a positive integer, the item change information is for characterizing that the quantity of the item indicated by the item identifier increases by a positive integer number. When the item quantity change in the item change information is a negative integer, the item change information is for characterizing that the quantity of the item indicated by the item identifier decreases by an absolute value of a negative number.

In some optional implementations of this embodiment, the item change information may include the item identifier, the item quantity change, and the quantity change probability value. Here, the quantity change probability value in the item change information is for characterizing the probability of the quantity change of the item indicated by the item identifier being the item quantity change.

In this embodiment, the user behavior information of a user in the unmanned store may be obtained after the executing body analyzes and processes the data acquired by the various data acquiring devices provided in the unmanned store.

Here, the user behavior information is for characterizing what behavior the user performs.

In some optional implementations of this embodiment, the user behavior information may include a behavior identifier. Here, behavior identifiers are used for uniquely identifying various behaviors the user may perform. For example, the behavior identifier may be a character string combined by digits, letters and symbols. For example, the various behaviors that may be performed by the user may include, but not limited to: walking, lifting an arm, putting a hand into a pocket, putting a hand into a shopping bag, standing still, reaching out to a shelf, passing an item, etc. Here, the user behavior information of the user is for characterizing that the user performs a behavior indicated by a user behavior identifier.

In some optional implementations of this embodiment, the user behavior information may include a behavior identifier and a user behavior probability value. Here, the user behavior probability value in the user behavior information of the user is for characterizing a probability that the user performs the behavior indicated by the user behavior identifier.

In some optional implementations of this embodiment, at least one human action recognition camera may be provided in the unmanned store, and shooting ranges of respective human action recognition cameras may cover respective areas for users to walk through in the unmanned store. In this way, the executing body may receive, in real time, each video frame acquired by the at least one human action recognition camera, and determine the user behavior information of the user in the area covered by the human action recognition camera based on the video frame acquired by each human action recognition camera in a second preset time length counted backward from the current moment.

In this embodiment, the executing body may store a user state information table of the unmanned store, wherein the user state information table stores the user state information of the user currently in the unmanned store. The user state information may include a user identifier, user position information, and a set of chosen item information.

wherein user identifiers may uniquely identify respective users in the unmanned store. For example, the user identifier may be a user name, a user mobile phone number, a user name of the user registered with the unmanned store, or which person time of entering the unmanned store from a preset moment (e.g., morning of the day) till the current time.

The user position information may characterize the position of the user in the unmanned store, and the user position information may be a two-dimensional coordinate or a three-dimensional coordinate. Optionally, the user position information includes at least one of: user left hand position information, user right hand position information, and user chest position information. Here, if the position indicated by the user left hand position information or the user right hand position information is near an item, it may indicate that the user is grabbing the item. while the user chest position information is for characterizing what specific position the user is standing at, which item he is facing, or which layer of which shelf he is facing. Here, the shelf is for storing items.

The chosen item information may include an item identifier; here, the chosen item information is for characterizing that the user chooses the item indicated by the item identifier.

The chosen item information may also include an item identifier and a quantity of chosen items; in this way, the chosen item information is for characterizing that the user has chosen the items indicated by the item identifiers in the quantity of the quantity of chosen items.

The chosen item information may also include an item identifier, a quantity of chosen item, and a probability of choosing the items; in this way, the probability of choosing the items in the chosen item information is for characterizing a probability that the user chooses the items indicated by the item identifiers in the quantity of chosen item.

In some optional implementations of this embodiment, the user state information may also include a set of user behavior information.

In this embodiment, because the user state information in the user state information table refers to the user state information before the current moment, while because it has been determined in step 201 that the quantity of the item stored in the unmanned store has changed, then the executing body may determine an increase or a decrease in the quantity of the item with a changed quantity based on the item change information of the item stored in the unmanned store. Specifically, there may exist the following situations:

First, increase of the quantity of the item: namely, there exists a situation that increase of the quantity of the item is caused by the user's putting the item back to the shelf. At this point, it needs to determine which user performs a behavior of “putting the item back to the shelf” based on the user behavior information of respective user, and delete third target chosen item information, or decrease the quantity of the chosen item in the third target chosen item information, or lower the probability of choosing the item in the third target chosen item information, wherein the third target chosen item information refers to the chosen item information corresponding to the item putted back to the shelf in the set of chosen item information of the user determined in the user state information table.

Second, decrease of the quantity of the item: namely, there exists a situation that decrease of the quantity of the item is caused by the user's taking the item away from the shelf. At this point, it needs to determine which user performs a behavior of “taking the item away from the shelf” based on the user behavior information of respective user, and add fourth target chosen item information to the set of the chosen item information of the user determined in the user state information table, or add the quantity of the chosen item in fifth target chosen item information, or increase the probability of choosing the item in the fifth target chosen item information, wherein the fourth target chosen item information includes an item identifier of the item taken away from the shelf, the quantity of the item taken away from the shelf, and a probability value of taking away the item indicated by the item identifier in the quantity of taking the item away from the shelf, and the fifth target chosen item information refers to the chosen item information corresponding to the item taken away from the shelf in the set of chosen item information of the user determined in the user state information table.

In some optional implementations of this embodiment, the executing body may update the user state information table of the unmanned store based on the item change information of respective item stored in the unmanned store and the user behavior information of respective user in the unmanned store.

In some optional implementations of this embodiment, for each target item whose quantity changes in the unmanned store and for each target user whose distance from the target item is smaller than a first preset distance threshold among users in the unmanned store, the executing body may calculate a probability value of the target user's choosing the target item based on a probability value of quantity decrease of the target item, the distance between the target user and the target item, and a probability of the target user's grabbing the item, and add first target chosen item information to the set of chosen item information of the target user in the user state information table, wherein the first target chosen item information is generated based on an item identifier of the target item and a calculated probability value of the target user's choosing the target item. Namely, with this optional implementation manner, the scope considered during updating the user state information table is narrowed from all users in the unmanned store to the users whose distances from the item is smaller than a first preset distance threshold, which may reduce the computational complexity, namely, reducing the computational resources needed for updating the user state information table.

Optionally, a probability value of the target user's choosing the target item may be calculated according to an equation below based on a probability value of quantity decrease of the target item, the distance between the target user and the target item, and a probability of the target user's grabbing the item:

$$P ( A got c ) = P ( c missing ) \frac{P ( A near c ) P ( A grab )}{{\sum }_{k ∈ K} P ( k near c ) P ( k grab )} \qquad ( 1 )$$

where:

c denotes the item identifier of the target item,

A denotes the user identifier of the target user,

K denotes a set of user identifiers of respective target users whose distances from the target item are smaller than the first preset distance threshold, k denotes any user identifier in K,

P(c missing) denotes a probability value of quantity decrease of the target item calculated based on the data acquired by the shelf product detection & recognition camera,

P(A near c) denotes a near degree value between the target user and the target item, P(A near c) is negatively correlated with the distance between the target user and the target item,

P(A grab) denotes a probability value of the target user's grabbing the item calculated based on the data acquired by the human action recognition camera,

P(k near c) denotes a near degree value between the user indicated by the user identifier k and the target item, P(k near c) is negatively correlated to the distance between the user indicated by the user identifier k and the target item,

P(k grab) denotes a probability value of the user indicated by the user identifier k for grabbing the item as calculated based on the data acquired by the human action recognition camera,

and P(A got c) denotes a calculated probability value of the target user's choosing the target item.

Optionally, a probability value of the target user's choosing the target item may also be calculated according to an equation below based on the probability value of quantity decrease of the target item, the distance between the target user and the target item, and the probability of the target user's grabbing the item:

$$P ( A got c ) = α P ( c missing ) \frac{P ( A near c ) P ( A grab ) + β}{{\sum }_{k ∈ K} P ( k near c ) P ( k grab ) + γ} + θ \qquad ( 2 )$$

Where c, A, K, k, P(c missing), P(A near c), P(A grab), P(k near c), P(k grab) and P(A got c) are construed identically to the above optional implementation, while α, β, γ, and θ are all preset constants.

Step 203: determining whether the user in the unmanned store has an item passing behavior.

In this embodiment, an executing body (e.g., the server in FIG. 1) of the method for information processing may determine whether the user in the unmanned store has an item passing behavior based on different data acquisition devices provided in the unmanned store in different implementation manners.

In some optional implementations of this embodiment, at least one human action recognition camera may be provided in the unmanned store, and shooting ranges of respective human action recognition cameras may cover respective areas for users to walk through in the unmanned store. In this way, the executing body may receive, in real time, each video frame acquired by the at least one human action recognition camera, and determine whether the user in the area covered by the human action recognition camera has an item passing behavior based on the video frame acquired by each human action recognition camera in a third preset time length counted backward from the current moment. For example, such video frames may be subjected to image recognition to recognize whether hands of two different users exist in the video frames and whether an item exists between the hands of the two different users; if yes, it may be determined that the human action recognition camera detects that the user has an item passing behavior. For another example, if it is detected that in two adjacent video frames among these video frames, a preceding video frame displays that an item is in user A's hand while the latter video frame displays that the item is in user B's hand, while the distance between user A and user B is smaller than the second preset distance threshold, it may be determined that the human action recognition camera detects that the users have an item passing behavior. If one human action recognition camera in the at least one human action recognition camera detects that the user has an item passing behavior, it may be determined that the user in the unmanned store has an item passing behavior. If none of the human action recognition cameras detects that the user has an item passing behavior, it may be determined that the user in the unmanned store does not have an item passing behavior.

In some optional implementations of this embodiment, at least one human action recognition camera may be provided in the unmanned store, and shooting ranges of respective human action recognition cameras may cover respective areas for users to walk through in the unmanned store. In this way, the step 203 may also be performed as follows:

First, user behavior information of respective user in the unmanned store may be acquired.

wherein the user behavior information of respective user in the unmanned store is obtained based on data outputted by the human action recognition cameras. Here, the user behavior information may include a behavior identifier and a user behavior probability value.

Second, it may be determined whether user behavior information with a behavior identifier for characterizing passing of an item with a user behavior probability value greater than a second preset probability value is present in the acquired user behavior information; if yes, it may be determined that the user in the unmanned store has an item passing behavior; if not, it may be determined that the user in the unmanned store does not have an item passing behavior.

Step 204: updating the user state information table based on the user behavior information of the user in the unmanned store in response to determining that the user in the unmanned store has the item passing behavior.

In this embodiment, because the user state information in the user state information table is the user state information before the current moment, and while because it has been determined in step 203 that the user in the unmanned store has an item passing behavior, which indicates that there is a possibility that user A passes item B to user C, i.e., the quantity of item B chosen by user A may decrease and the quantity of item B chosen by user C may increase, then the executing body may update the user state information table based on the user behavior information of the user in the unmanned store in various implementation manners.

In some optional implementations of this embodiment, the user behavior information may include a behavior identifier. Namely, if user A passes the item out, the user behavior information of the user A may include a behavior identifier for indicating the item passing behavior, and then the executing body may reduce the quantity of the chosen item or the probability of choosing the item in each chosen item information in the set of chosen item information of user A in the user state information table.

In some optional implementations of this embodiment, the user behavior information may include a behavior identifier, a behavior target item, and a behavior target user, namely, if user A passes item B to user C, then user A's user behavior information may include: a behavior identifier for indicating the item passing behavior, B and C; and then the executing body may reduce the quantity of the chosen item or the probability of choosing the item in the chosen item information corresponding to item B in the set of chosen item information of user A in the user state information table, and may alternatively increase the quantity of the chosen item or the probability of choosing the item in the chosen item information corresponding to item B in the set of chosen item information of user C in the user state information table.

In some optional implementations of this embodiment, at least one human action recognition camera and at least one ceiling product detection & recognition camera may be both provided in the unmanned store, and shooting ranges of respective human action recognition cameras may cover respective areas available for users to walk through in the unmanned store, and shooting ranges of the respective ceiling product detection & recognition cameras may cover non-shelf areas in the unmanned store. In this way, the executing body may receive, in real time, each video frame acquired by the at least one human action recognition camera, and determine the user behavior information of the user in the area covered by the human action recognition camera based on a difference between a video frame acquired by each human action recognition camera at the current moment and a video frame acquired before the current moment. The executing body may also receive, in real time, each video frame acquired by the at least one ceiling product detection & recognition camera, and determine the item identifiers of the items within non-shelf area covered by the ceiling product detection & recognition camera based on the video frame acquired by each ceiling product detection & recognition camera in a fourth preset time length counted backward from the current moment. If the human action recognition camera detects existence of the user's item passing behavior in area A1 at time T, the item identifier I of the item determined by the ceiling product detection & recognition camera corresponding to the area A1 at time T may be acquired, and finally it may be determined that the item indicated by the item identifier I is passed between users in area A1 at time T.

In some optional implementations of this embodiment, the user behavior information may include a behavior identifier, a behavior target item, a behavior target user, and a behavior probability value, namely, if the probability that user A passes item B to user C is D, then the user A's user behavior information may include: a behavior identifier for indicating the item passing behavior, B, C, and D. In this way, the step 204 may be alternatively performed as follows:

in response to determining that the users in the unmanned store have an item passing behavior, wherein a first user passes the item to a second user, calculating a probability value of the first user's choosing the passed item and a probability value of the second user's choosing the passed item based on a probability value of the first user's passing the item to the second user and a probability of presence of the passed item in the area where the first user passes the item to the second user, respectively, and adding second target chosen item information to the set of chosen item information of the first user in the user state information table, and adding a third target chosen item information to the set of chosen item information of the second user in the user state information table, wherein the second chosen item information is generated based on the item identifier of the passed item and the calculated probability value of the first user's choosing the passed item, and the third chosen item information is generated based on the item identifier of the passed item and the calculated probability value of the second user's choosing the passed item.

Optionally, the probability value of the first user's choosing the passed item and the probability value of the second user's choosing the passed item may be calculated respectively according to the following equation, based on the probability value of the first user's passing the item to the second user and the probability of presence of the passed item in the area where the first user passes the item to the second user:

P(B got d)=P(A pass B)P(d) (3)

P(A got d)=1−P(B got d) (4)

where:

d denotes the item identifier of the passed item,

A denotes the user identifier of the first user,

B denotes the user identifier of the second user,

P(A pass B) denotes the probability value of the first user's passing the item to the second user calculated based on the data acquired by the human action recognition camera,

P(d) denotes a probability value of presence of the item indicated by the item identifier d in the area where the first user passes the item to the second user, calculated based on the data acquired by the ceiling product detection & recognition camera,

while P(B got d) is a calculated probability value of the second user's choosing the passed item,

and P(A got d) denotes a calculated probability value of the first user's choosing the passed item.

Optionally, the probability value of the first user's choosing the passed item and the probability value of the second user's choosing the passed item may alternatively be calculated based on the probability value of the first user's passing the item to the second user and the probability of presence of the passed item in the area where the first user passes the item to the second user according to the following equation, respectively:

P(B got d)=αP(A pass B)P(d)+β (5)

P(A got d)=1−P(B got d) (6)

where d, A, B, P(A pass B) and P(d) are construed identically to the above optional implementation manner, while α and β are all preset constants.

The method provided by the embodiments of the present disclosure reduces the times of updating the user state information table and then saves computational resources by updating, when detecting a change in the quantity of the item stored in the unmanned store, the user state information table of the unmanned store based on the item change information of the item stored in the unmanned store and the user behavior information of the user in the unmanned store, or updating, when detecting that the user in the unmanned store has an item passing behavior, the user state information table based on the user behavior information of the user in the unmanned store.

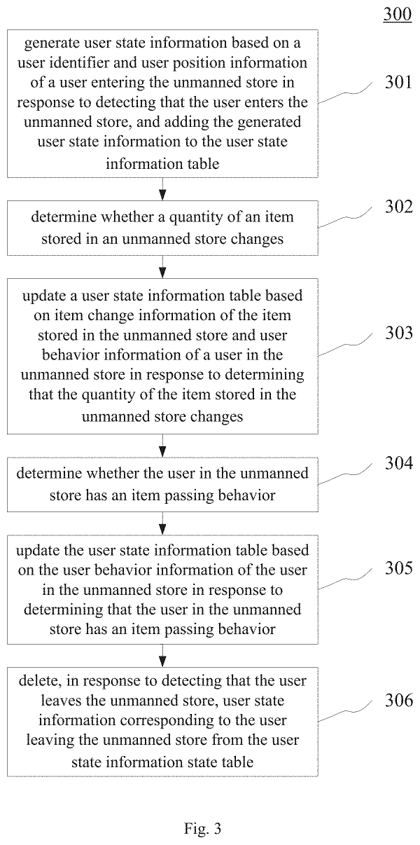

Continue to refer to FIG. 3, which shows a flow 300 of a further embodiment of a method for information processing according to the present disclosure. The flow 300 of the method for information processing comprises steps of:

Step 301: generating user state information based on a user identifier and user position information of a user entering the unmanned store in response to detecting that the user enters the unmanned store, and adding the generated user state information to the user state information table.

In this embodiment, an executing body (e.g., the server shown in FIG. 1) for information processing may detect whether there is a user entering the unmanned store from outside of the unmanned store by adopting a plurality of implementation manners.

In some optional implementations of this embodiment, at least one of a light curtain and an auto gate sensor may be provided at an entrance of the unmanned store. In this way, the executing body may determine that the user's entering the unmanned store is detected in response to determining that at least one of the light curtain sensor and the auto gate at the entrance of the unmanned store detects that the user passes.

In some optional implementations of this embodiment, a sensing gate may be provided at the entrance of the unmanned store. In this way, the executing body may determine that the user's entering the unmanned store is detected in response to determining that the sensing gate at the entrance of the unmanned store detects that the user passes.

In this embodiment, when detecting that a user enters the unmanned store, the executing body may first determine the user identifier and the user position information of the user entering the unmanned store by adopting various implementation manners, then generate user state information based on the determined user identifier and user position information, and finally add the generated user state information to the user state information table.

In some optional implementations of this embodiment, a two-dimensional scanning device may be provided at the entrance of the unmanned store. In this way, the user may pre-register to become a user of the unmanned store using a terminal device, and during the registration process, the executing body generates a two-dimensional code for the user as the user identifier. In this way, when the user comes to the unmanned store, he/she may present his/her two-dimensional code with a terminal device to the two-dimensional code scanning device provided at the entrance of the unmanned store, and after the two-dimensional code scanning device provided at the entrance of the unmanned store scans the terminal device and obtains the two-dimensional code of the user, it may transmit the scanned two-dimensional code to the executing body, and then the executing body may, after authenticating the two-dimensional code as the user identifier of the registered user, determine a detection of the user's entering the unmanned store and use the authenticated two-dimensional code as the user identifier of the user entering the unmanned store.

In some optional implementations of this embodiment, at least one human tracking camera may be provided at the entrance inside the unmanned store, wherein shooting ranges of the at least one human tracking camera provided at the entrance inside the store may cover an entrance area inside the unmanned store. In this way, the executing body may receive, in real time, each video frame acquired by respective human tracking camera whose shooting range covers the entrance area inside the store, and when a user not appearing in a video frame acquired in a fifth preset time length counted backward from the current moment appears in the video frame acquired at the current moment, determine that the user's entering the unmanned store is detected, and perform human face recognition to the user face image appearing in the video frame acquired at the current moment to obtain the user identifier of the user entering the unmanned store.

In some optional implementations of this embodiment, at least one human tracking camera may be provided in the unmanned store, and shooting ranges of the at least one human tracking camera may cover areas available for users to walk through in the unmanned store. In this way, the executing body may receive, in real time, each video frame acquired by the at least one human tracking camera and may determine the user position information of the user based on the position and rotated angle of each human tracking camera and a position of the user image part in the acquired video frame image.

In some optional implementations of this embodiment, the user may also carry a terminal device that has a positioning function; in this way, the executing body may use the position of the terminal device as the user position of the user by utilizing an LBS (Location Based Service).

In this embodiment, the user state information may include the user identifier and the user position information; as such, the executing body may directly generate the user state information using the determined user identifier and user position information.

In some optional implementations of this embodiment, the user state information may include a user identifier, user position information, a set of user behavior information, and a set of chosen item information. In this way, the executing body may generate user state information based on the determined user identifier and user position information, an empty set of user behavior information, and an empty set of chosen item information; wherein the user behavior information includes a behavior identifier and a user behavior probability value, and the chosen item information may include the item identifier, the quantity of the chosen item, and a probability value of choosing the item.

Step 302: determining whether a quantity of an item stored in an unmanned store changes.

Step 303: updating a user state information table based on item change information of the item stored in the unmanned store and user behavior information of a user in the unmanned store in response to determining that the quantity of the item stored in the unmanned store changes.

Step 304: determining whether the user in the unmanned store has an item passing behavior.

Step 305: updating the user state information table based on the user behavior information of the user in the unmanned store in response to determining that the user in the unmanned store has an item passing behavior.

In this embodiment, specific operations of step 302, step 303, step 304, and step 305 are substantially identical to the operations of step 201, step 202, step 203, and step 204, which are not detailed here.

Step 306: deleting, in response to detecting that the user leaves the unmanned store, user state information corresponding to the user leaving the unmanned store from the user state information state table.

In this embodiment, whether there exists a user leaving the unmanned store may be detected by adopting various implementation manners.

In some optional implementations of this embodiment, at least one of a light curtain sensor and an auto gate may be provided at an exit of the unmanned store. In this way, the executing body may determine that the user's leaving the unmanned store is detected in response to determining that at least one of the light curtain sensor and the auto gate at the exit of the unmanned store detects that the user passes.

In some optional implementations of this embodiment, a sensing gate may be provided at an exit of the unmanned store. In this way, the executing body may determine that the user's leaving the unmanned store is detected in response to determining that the sensing gate at the exit of the unmanned store detects that the user passes.

In this embodiment, when detecting that a user leaves the unmanned store, the executing body may first determine the user identifier of the user leaving the unmanned store by adopting various implementation manners, then delete the user state information corresponding to the user identifier determined from the user state information table.

In some optional implementations of this embodiment, a two-dimensional scanning device may be provided at an exit of the unmanned store. In this way, when the user leaves the unmanned store, he/she may display his/her two-dimensional code with a terminal device to the two-dimensional code scanning device provided at the exit of the unmanned store, and after the two-dimensional code scanning device provided at the exit of the unmanned store scans the terminal device and obtains the two-dimensional code of the user, it may transmit the scanned two-dimensional code to the executing body, and then the executing body may, after authenticating the two-dimensional code as the user identifier of the registered user or determining that the user indicated by the two-dimensional code has completed a payment procedure, determine a detection of the user's leaving the unmanned store and use the authenticated two-dimensional code as the user identifier of the user leaving the unmanned store.

In some optional implementations of this embodiment, at least one camera may be provided at an exit outside the unmanned store, wherein the shooting range of the at least one camera provided at the exit outside the store may cover an exit area outside the unmanned store. In this way, the executing body may receive, in real time, each video frame acquired by respective camera whose shooting range covers the exit area outside the store, and when a user not appearing in a video frame acquired in a sixth preset time length counted back from the current moment appears in the video frame acquired at the current moment, determine that the user's leaving the unmanned store is detected, and perform human face recognition to the user face image appearing in the video frame acquired at the current moment to obtain the user identifier of the user leaving the unmanned store.

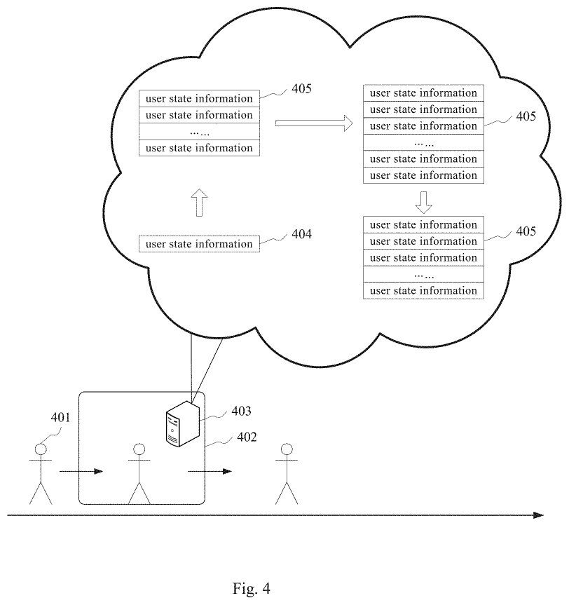

Continue to refer to FIG. 4, which is a schematic diagram of an application scenario of the method for information processing according to the present disclosure. In the application scenario of FIG. 4, a user 401 enters an unmanned store 402; then, a server 403 in the unmanned store 402 detects the user's entering the unmanned store and generates user state information 404 based on the user identifier and user position information of the user 401 entering the unmanned store, and adds the generated user state information 404 to the user state information table 405. Next, the server 403 detects that the quantity of the item in the unmanned store changes, and then updates the user state information table 405 of the unmanned store based on the item change information of the item stored in the unmanned store and user behavior information of the user in the unmanned store. Then, the server 403 detects that the user in the unmanned store has an item passing behavior and re-updates the user state information table 405 based on the user behavior information of the user in the unmanned store. Finally, the server 403 detects that the user 401 leaves the unmanned store and then deletes the user state information corresponding to the user 401 from the user state information table 405.

It may be seen from FIG. 3 that compared with the embodiment corresponding to FIG. 2, the flow 300 of the method for information processing in this embodiment has additional steps of adding, when detecting that the user enters the unmanned store, the user state information generated based on the user identifier and the user position information of the user entering the unmanned store to the user state information table, and deleting, when detecting that the user leaves the unmanned store, the user state information corresponding to the user leaving the unmanned store from the user state information table. In this way, the solution described in this embodiment may implement a more comprehensive information processing and further reduce the storage resources needed for storing the user state information table.

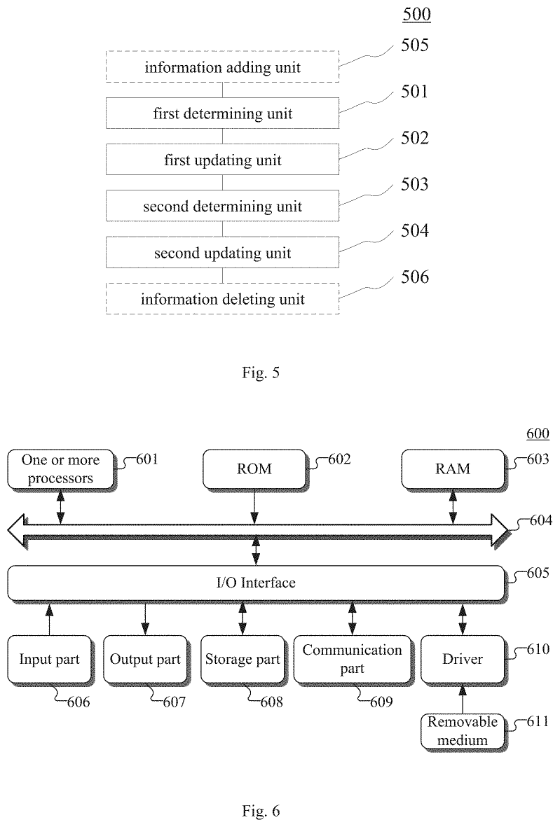

Further refer to FIG. 5. To implement the methods shown in respective figures above, the present disclosure provides an embodiment of an apparatus for information processing. The apparatus embodiment corresponds to the method embodiment shown in FIG. 2. The apparatus may be specifically applied to various electronic devices.

As shown in FIG. 5, the apparatus 500 for information processing in this embodiment comprises: a first determining unit 501, a first updating unit 502, a second determining unit 503, and a second updating unit 504. Specifically, the first determining unit 501 is configured for determining whether a quantity of an item stored in an unmanned store changes; the first updating unit 502 is configured for updating a user state information table based on item change information of the item stored in the unmanned store and user behavior information of a user in the unmanned store in response to determining that the quantity of the item stored in the unmanned store changes; the second determining unit 503 is configured for determining whether the user in the unmanned store has an item passing behavior; and the second updating unit 504 is configured for updating the user state information table based on the user behavior information of the user in the unmanned store in response to determining that the user in the unmanned store has the item passing behavior.

In this embodiment, specific operations of the first determining unit 501, the first updating unit 502, the second determining unit 503, and the second updating unit 504 of the apparatus 500 for information processing, as well as the technical effects achieved thereby, may refer to relevant depictions of step 201, step 202, step 203, and step 204 in the embodiment corresponding to FIG. 2, respectively, which thus will not be detailed here.

In some optional implementations of this embodiment, the apparatus 500 may further comprise: an information adding unit 505 configured for generating user state information based on a user identifier and user position information of the user entering the unmanned store in response to detecting that the user enters the unmanned store, and adding the generated user state information to the user state information table.

In some optional implementations of this embodiment, the apparatus 500 may further comprise: an information deleting unit 506 configured for deleting user state information corresponding to the user leaving the unmanned store from the user state information table in response to detecting that the user leaves the unmanned store.

In some optional implementations of this embodiment, at least one of the following may be provided in the unmanned store: a shelf product detection & recognition camera, a human tracking camera, a human action recognition camera, a ceiling product detection & recognition camera, and a gravity sensor.

In some optional implementations of this embodiment, the user state information may include a user identifier, user position information, a set of user behavior information, and a set of chosen item information, wherein the user behavior information includes a behavior identifier and a user behavior probability value, and the chosen item information includes an item identifier, the quantity of the chosen item, and a probability value of choosing the item, and the information adding unit 505 may further be configured for: determining the user identifier and the user position information of the user entering the unmanned store, wherein the determined user identifier and user position information are obtained based on data outputted by the human tracking camera; and generating new user state information based on the determined user identifier and user position information, an empty set of user behavior information, and an empty set of chosen item information.

In some optional implementations of this embodiment, the item change information may include an item identifier, a change in the quantity of the item, and a quantity change probability value, and the first determining unit may include: an item change information acquiring module (not shown in FIG. 5) configured for acquiring item change information of respective item stored in the unmanned store, wherein the item change information is obtained based on at least one of: data outputted by the shelf product detection & recognition camera and data outputted by the gravity sensor; a first determining module (not shown in FIG. 5) configured for determining that the quantity of the item stored in the unmanned store changes in response to determining that item change information with a quantity change probability value being greater than a first preset probability value exists in the acquired item change information; and a second determining module (not shown in FIG. 5) configured for determining that the quantity of the item stored in the unmanned store does not change in response to determining that item change information with the quantity change probability value being greater than a first preset probability value does not exist in the acquired item change information.

In some optional implementations of this embodiment, the second determining unit 503 may comprise: a user behavior information acquiring module (not shown in FIG. 5) configured for acquiring user behavior information of respective user in the unmanned store, wherein the user behavior information is obtained based on data outputted by the human action recognition camera; a third determining module (not shown in FIG. 5) configured for determining that the user in the unmanned store has the item passing behavior in response to presence of user behavior information with a behavior identifier for characterizing passing of the item and a user behavior probability value being greater than a second preset probability value in the acquired user behavior information; and a fourth determining module (not shown in FIG. 5) configured for determining that the user in the unmanned store does not have an item passing behavior in response to absence of the user behavior information with the behavior identifier for characterizing passing of the item and the user behavior probability value being greater than the second preset probability value in the acquired user behavior information.

In some optional implementations of this embodiment, a light curtain sensor may be provided in front of a shelf in the unmanned store; and the user behavior information may be obtained based on at least one of: data outputted by the human action recognition camera and data outputted by the light curtain sensor disposed in front of the shelf in the unmanned store.

In some optional implementations of this embodiment, the user position information may include at least one of: user left hand position information, user right hand position information, and user chest position information.

In some optional implementations of this embodiment, at least one of a light curtain sensor and an auto gate may be provided at an entrance of the unmanned store, and the information adding unit 505 may further be configured for determining that the user's entering the unmanned store is detected in response to determining that at least one of the light curtain sensor and the auto gate at the entrance of the unmanned store detects that the user passes; or determining that the user's entering the unmanned store is detected in response to determining that the human tracking camera detects that the user enters the unmanned store.

In some optional implementations of this embodiment, at least one of the light curtain sensor and an auto gate may be provided at an exit of the unmanned store, and the information deleting unit 506 may further be configured for: determining that the user's leaving the unmanned store is detected in response to determining that at least one of the light curtain sensor and the auto gate at the exit of the unmanned store detects that the user passes; or determining that the user's leaving the unmanned store is detected in response to determining that the human tracking camera detects that the user leaves the unmanned store.

In some optional implementations of this embodiment, the first updating unit 502 may further be configured for: for each target item whose quantity changes in the unmanned store and for each target user whose distance from the target item is smaller than a first preset distance threshold among users in the unmanned store, calculating a probability value of the target user's choosing the target item based on a probability value of quantity decrease of the target item, the distance between the target user and the target item, and a probability of the target user's grabbing the item, and adding first target chosen item information to the set of chosen item information of the target user in the user state information table, wherein the first target chosen item information is generated based on an item identifier of the target item and a calculated probability value of the target user's choosing the target item.

In some optional implementations of this embodiment, the step of calculating a probability value of the target user's choosing the target item based on a probability value of quantity decrease of the target item, the distance between the target user and the target item, and a probability of the target user's grabbing the item may comprise: calculating the probability value of the target user's choosing the target item according to an equation below:

$$P ( A got c ) = P ( c missing ) \frac{P ( A near c ) P ( A grab )}{{\sum }_{k ∈ K} P ( k near c ) P ( k grab )}$$

where c denotes the item identifier of the target item, A denotes the user identifier of the target user, K denotes a set of user identifiers of respective target users whose distances from the target item are smaller than the first preset distance threshold, k denotes any user identifier in K, P(c missing) denotes a probability value of quantity decrease of the target item calculated based on the data acquired by the shelf product detection & recognition camera, P(A near c) denotes a near degree value between the target user and the target item, P(A near c) is negatively correlated with the distance between the target user and the target item, P(A grab) denotes a probability value of the target user's grabbing the item calculated based on the data acquired by the human action recognition camera, P(k near c) denotes a near degree value between the user indicated by the user identifier k and the target item, P(k near c) is negatively correlated to the distance between the user indicated by the user identifier k and the target item, P(k grab) denotes a probability value of the user indicated by the user identifier k for grabbing the item as calculated based on the data acquired by the human action recognition camera, and P(A got c) denotes a calculated probability value of the target user's choosing the target item.

In some optional implementations of this embodiment, the second updating unit 504 may further be configured for: in response to determining that the user in the unmanned store has an item passing behavior, wherein a first user passes the item to a second user, calculating a probability value of the first user's choosing the passed item and a probability value of the second user's choosing the passed item based on a probability value of the first user's passing the item to the second user and a probability value of presence of the passed item in an area where the first user passes the item to the second user, respectively, and adding second target chosen item information to the set of chosen item information of the first user in the user state information table, and adding a third target chosen item information to the set of chosen item information of the second user in the user state information table, wherein the second target chosen item information is generated based on an item identifier of the passed item and a calculated probability value of the first user's choosing the passed item, and the third target chosen item information is generated based on the item identifier of the passed item and a calculated probability value of the second user's choosing the passed item.

In some optional implementations of this embodiment, the step of calculating a probability value of the first user's choosing the passed item and a probability value of the second user's choosing the passed item based on a probability value of the first user's passing the item to the second user and a probability value of presence of the passed item in an area where the first user passes the item to the second user, respectively, may comprise: calculating the probability value of the first user's choosing the passed item and the probability value of the second user's choosing the passed item according to an equation below, respectively:

P(B got d)=P(A pass B)P(d)

P(A got d)=1−P(B got d)

where d denotes the item identifier of the passed item, A denotes the user identifier of the first user, B denotes the user identifier of the second user, P(A pass B) denotes the probability value of the first user's passing the item to the second user calculated based on the data acquired by the human action recognition camera, P(d) denotes a probability value of presence of the item indicated by the item identifier d in the area where the first user passes the item to the second user, calculated based on the data acquired by the ceiling product detection & recognition camera, while P(B got d) is a calculated probability value of the second user's choosing the passed item, and P(A got d) denotes a calculated probability value of the first user's choosing the passed item.

It needs to be noted that implementation details and technical effects of respective units in the apparatus for information processing provided by the embodiments of the present application may refer to the descriptions in other embodiments of the present disclosure, which thus will not be detailed.

Now, refer to FIG. 6, which shows a structural schematic diagram of a computer system 600 of a server, which is adapted for implementing the embodiments of the present disclosure. The computer system shown in FIG. 6 is only an example, which should not bring any limitation to the functions and use scopes of the embodiments of the present disclosure.

As shown in FIG. 6, the computer system 600 comprises one or more processors 601 which may perform various kinds of appropriate actions and processing based on computer program stored in a read-only memory (ROM) 602 or computer program loaded into the random-access memory (RAM) 603 from a memory part 608. In RAM 603, there may also store various kinds of programs and data needed for operations of the system 600. One or more processors 601, ROM 602, and RAM 603 are connected with each other via a bus 604. The input/output (I/O) interface 605 may also be connected to the bus 604.

A plurality of components are connected to the I/O interface 605, comprising: an input part 606 including a keyboard, a mouse, and etc.; an output part 607 including such as a CRT (Cathode Ray Tube), an LCD (Liquid Crystal Display), and a loudspeaker, etc.; a memory part 608 including a hard disk, etc.; and a communication part 609 including a network interface card such as a LAN (Local Area Network) card, a modem, etc. The communication part 609 performs communication processing via a network such as the Internet. A driver 610 is also connected to the I/O interface 605 as needed. A removable medium 611, such as a magnetic disk, an optical disk, a magneto-optical disk, and a semiconductor memory, etc., is mounted on the driver 610 as needed, so as to facilitate the computer program read therefrom to be installed in the memory part 608.

Particularly, according to the embodiments of the present disclosure, the processes described above with reference to the flow diagrams may be implemented as computer software programs. For example, an embodiment of the present disclosure includes a computer program product that has a computer program carried on a computer-readable medium, the computer program containing computer codes for executing the methods shown in the flow diagrams. In such an embodiment, the computer programs may be downloaded and installed from a network through the communication part 609 and/or installed from the removable medium 611. When being executed by the one or more processors 601, the computer programs execute the functions limited in the methods of the present disclosure. It needs to be noted that the computer readable medium as described in the present disclosure may be a computer-readable signal medium or a computer-readable storage medium or any combination thereof. The computer-readable storage medium, for example, may be, but not limited to, an electrical, magnetic, optical, electromagnetic, infrared, or semiconductor system, apparatus or device, or any combination thereof. More specific examples of the computer-readable storage medium may include, but not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof. In the present disclosure, the computer-readable storage medium may be any tangible medium containing or storing a program that may be used by an instruction executing system, apparatus, or device or used in combination therewith. Further, in the present disclosure, the computer-readable signal medium may include a data signal propagated in a baseband or as part of a carrier, in which computer-readable program code are carried. A data signal propagated in such a way may assume a plurality of forms, including, but not limited to, an electromagnetic signal, an optical signal, or any appropriate combination thereof. The computer-readable signal medium may also be any computer-readable medium other than the computer-readable storage medium, which computer-readable medium may send, propagate or transmit the programs used by the instruction executing system, apparatus or device or used in combination therewith. The program code embodied on the computer-readable medium may be transmitted using any appropriate medium, including, but not limited to: wireless, wired, cable, RF, etc., or any appropriate combination thereof.

One or more programming languages or a combination thereof may be used to compile the computer program codes for executing the operations in the present disclosure. The programming languages include object-oriented programming languages (such as Java, Smalltalk, C++), and also include conventional procedural programming languages (such as “C” language or similar programming languages). The program code may be completely executed on a user computer, partially executed on the user computer, executed as an independent software packet, or partially executed on the user computer while partially executed on the remote computer, or completely executed on the remote computer or the server. In a scene associated with a remote computer, the remote computer may be connected to the user computer via any kind of network (including a local area network (LAN) or a wide area network (WAN), or may be connected to the external computer (for example, connected via the Internet through an Internet Service Provider).

The flow diagrams and block diagrams in the drawings illustrate system architectures, functions, and operations possibly implemented by the system, method, and computer program product of various embodiments of the present disclosure. At this point, each block in the flow diagrams or block diagrams may represent a module, a program segment, or part of codes, wherein the module, program segment, or part of codes contain one or more executable instructions for implementing a prescribed logic function. It should also be noted that in some alternative implementations, the functions annotated in the blocks may also occur in a sequence different from what is indicated in the drawings. For example, two successively expressed blocks actually may be executed substantially in parallel, and they may be sometimes executed in a reverse order, dependent on the functions involved. It should also be noted that each block in the block diagrams and/or flow diagrams and a combination of blocks in the block diagrams and/or flow diagrams may be implemented by a specific hardware-based system for executing a prescribed function or operation, or may be implemented by a combination of specific hardware and computer instructions.

The units mentioned in the embodiments of the present disclosure may be implemented by software or by hardware. The units as described may also be provided in a processor. For example, they may be described as: a processor comprising a first determining unit, a first updating unit, a second determining unit, and a second updating unit, wherein names of these units do not constitute a limitation to the units per se in some circumstances. For example, the first unit may also be described as “a unit for determining whether a quantity of the item stored in the unmanned store changes.”

In another aspect, the present disclosure further provides a computer-readable medium; the computer-readable medium may be included in the apparatus described in the embodiments; or may be separately provided, without being installed in the apparatus. The computer-readable medium carries one or more programs that, when being executed by the apparatus, cause the apparatus to: determine whether a quantity of an item stored in an unmanned store changes; update a user state information table based on item change information of the item stored in the unmanned store and user behavior information of a user in the unmanned store in response to determining that the quantity of the item stored in the unmanned store changes; determine whether the user in the unmanned store has an item passing behavior; and update the user state information table based on the user behavior information of the user in the unmanned store in response to determining that the user in the unmanned store has the item passing behavior.

What have been described above are only preferred embodiments of the present disclosure and an illustration of the technical principle as exerted. Those skilled in the art should understand, the scope of invention in the present disclosure is not limited to the technical solution resulting from a specific combination of the technical features, and meanwhile, should also cover other technical solutions resulting from any combination of the technical features or their equivalent features without departing from the inventive concept. For example, a technical solution resulting from mutual substitution of the features and those technical features disclosed (not limited to) in the present disclosure with similar functions.

What is claimed is:

1. A method for information processing, comprising:
determining whether a quantity of an item stored in an unmanned store changes;
updating a user state information table based on item change information of the item stored in the unmanned store and user behavior information of a user in the unmanned store in response to determining that the quantity of the item stored in the unmanned store changes;
determining whether the user in the unmanned store has an item passing behavior; and
updating the user state information table based on the user behavior information of the user in the unmanned store in response to determining that the user in the unmanned store has the item passing behavior.

2. The method according to claim 1, further comprising:
generating user state information based on a user identifier and user position information of the user entering the unmanned store in response to detecting that the user enters the unmanned store, and adding the generated user state information to the user state information table.

3. The method according to claim 2, further comprising:
deleting user state information corresponding to the user leaving the unmanned store from the user state information table in response to detecting that the user leaves the unmanned store.

4. The method according to claim 3, wherein at least one of the following is provided in the unmanned store: a shelf product detection & recognition camera, a human tracking camera, a human action recognition camera, a ceiling product detection & recognition camera, and a gravity sensor.

5. The method according to claim 4, wherein the user state information includes the user identifier, the user position information, a set of user behavior information, and a set of chosen item information, wherein the user behavior information includes a behavior identifier and a user behavior probability value, and the chosen item information includes an item identifier, the quantity of the chosen item, and a probability value of choosing the item, and wherein the generating user state information based on a user identifier and user position information of the user entering the unmanned store comprises:
determining the user identifier and the user position information of the user entering the unmanned store, wherein the determined user identifier and user position information are obtained based on data outputted by the human tracking camera; and
generating new user state information based on the determined user identifier and user position information, an empty set of user behavior information, and an empty set of chosen item information.

6. The method according to claim 5, wherein the item change information includes an item identifier, a change in the quantity of the item, and a quantity change probability value, and wherein the determining whether the quantity of the item stored in an unmanned store changes comprises:
acquiring item change information of respective item stored in the unmanned store, wherein the item change information is obtained based on at least one of: data outputted by the shelf product detection & recognition camera, and data outputted by the gravity sensor;
determining that the quantity of the item stored in the unmanned store changes in response to determining that the item change information with a quantity change probability value being greater than a first preset probability value exists in the acquired item change information; and
determining that the quantity of the item stored in the unmanned store does not change in response to determining that item change information with the quantity change probability value being greater than a first preset probability value does not exist in the acquired item change information.

7. The method according to claim 6, wherein the determining whether the user in the unmanned store has an item passing behavior comprises:
acquiring user behavior information of respective user in the unmanned store, wherein the user behavior information is obtained based on data outputted by the human action recognition camera;
determining that the user in the unmanned store has the item passing behavior in response to presence of user behavior information with a behavior identifier for characterizing passing of the item and a user behavior probability value being greater than a second preset probability value in the acquired user behavior information; and
determining that the user in the unmanned store does not have an item passing behavior in response to absence of the user behavior information with the behavior identifier for characterizing passing of the item and the user behavior probability value being greater than the second preset probability value in the acquired user behavior information.

8. The method according to claim 7, wherein a light curtain sensor is provided in front of a shelf in the unmanned store; and the user behavior information is obtained based on at least one of: data outputted by the human action recognition camera and data outputted by the light curtain sensor disposed in front of the shelf in the unmanned store.

9. The method according to claim 8, wherein the user position information includes at least one of: user left hand position information, user right hand position information, and user chest position information.

10. The method according to claim 9, wherein at least one of a light curtain sensor and an auto gate is provided at an entrance of the unmanned store, and wherein the detecting that the user enters the unmanned store comprises:
determining that the user's entering the unmanned store is detected in response to determining that at least one of the light curtain sensor and the auto gate at the entrance of the unmanned store detects that the user passes; or
determining that the user's entering the unmanned store is detected in response to determining that the human tracking camera detects that the user enters the unmanned store.

11. The method according to claim 10, wherein at least one of the light curtain sensor and an auto gate is provided at an exit of the unmanned store, and wherein the detecting that the user leaves the unmanned store comprises:
determining that the user's leaving the unmanned store is detected in response to determining that at least one of the light curtain sensor and the auto gate at the exit of the unmanned store detects that the user passes; or
determining that the user's leaving the unmanned store is detected in response to determining that the human tracking camera detects that the user leaves the unmanned store.

12. The method according to claim 11, wherein the updating a user state information table based on the item change information of the item stored in the unmanned store and the user behavior information of the user in the unmanned store comprises:
for each target item whose quantity changes in the unmanned store and for each target user whose distance from the target item is smaller than a first preset distance threshold among users in the unmanned store, calculating a probability value of the target user's choosing the target item based on a probability value of quantity decrease of the target item, the distance between the target user and the target item, and a probability of the target user's grabbing the item, and adding first target chosen item information to the set of chosen item information of the target user in the user state information table, wherein the first target chosen item information is generated based on an item identifier of the target item and a calculated probability value of the target user's choosing the target item.

13. The method according to claim 12, wherein the calculating a probability value of the target user's choosing the target item based on a probability value of quantity decrease of the target item, the distance between the target user and the target item, and a probability of the target user's grabbing the item comprises:
calculating the probability value of the target user's choosing the target item according to an equation below:
$$P ( A got c ) = P ( c missing ) \frac{P ( A near c ) P ( A grab )}{{\sum }_{k ∈ K} P ( k near c ) P ( k grab )}$$
where c denotes the item identifier of the target item, A denotes the user identifier of the target user, K denotes a set of user identifiers of respective target users whose distances from the target item are smaller than the first preset distance threshold, k denotes any user identifier in K, P(c missing) denotes a probability value of quantity decrease of the target item calculated based on the data acquired by the shelf product detection & recognition camera, P(A near c) denotes a near degree value between the target user and the target item, P(A near c) is negatively correlated with the distance between the target user and the target item, P(A grab) denotes a probability value of the target user's grabbing the item calculated based on the data acquired by the human action recognition camera, P(k near c) denotes a near degree value between the user indicated by the user identifier k and the target item, P(k near c) is negatively correlated to the distance between the user indicated by the user identifier k and the target item, P(k grab) denotes a probability value of the user indicated by the user identifier k for grabbing the item as calculated based on the data acquired by the human action recognition camera, and P(A got c) denotes a calculated probability value of the target user's choosing the target item.

14. The method according to claim 13, wherein the updating the user state information table based on the user behavior information of the user in the unmanned store in response to determining that the user in the unmanned store has an item passing behavior further comprises:
in response to determining that the user in the unmanned store has an item passing behavior, wherein a first user passes the item to a second user, calculating a probability value of the first user's choosing the passed item and a probability value of the second user's choosing the passed item based on a probability value of the first user's passing the item to the second user and a probability value of presence of the passed item in an area where the first user passes the item to the second user, respectively, and adding second target chosen item information to the set of chosen item information of the first user in the user state information table, and adding a third target chosen item information to the set of chosen item information of the second user in the user state information table, wherein the second target chosen item information is generated based on an item identifier of the passed item and a calculated probability value of the first user's choosing the passed item, and the third target chosen item information is generated based on the item identifier of the passed item and a calculated probability value of the second user's choosing the passed item.

15. The method according to claim 14, wherein the calculating a probability value of the first user's choosing the passed item and a probability value of the second user's choosing the passed item based on a probability value of the first user's passing the item to the second user and a probability value of presence of the passed item in an area where the first user passes the item to the second user, respectively, comprises:
calculating the probability value of the first user's choosing the passed item and the probability value of the second user's choosing the passed item according to an equation below, respectively:
P(B got d)=P(A pass B)P(d)
P(A got d)=1−P(B got d)
where d denotes the item identifier of the passed item, A denotes the user identifier of the first user, B denotes the user identifier of the second user, P(A pass B) denotes the probability value of the first user's passing the item to the second user calculated based on the data acquired by the human action recognition camera, P(d) denotes a probability value of presence of the item indicated by the item identifier d in the area where the first user passes the item to the second user, calculated based on the data acquired by the ceiling product detection & recognition camera, while P(B got d) is a calculated probability value of the second user's choosing the passed item, and P(A got d) denotes a calculated probability value of the first user's choosing the passed item.

16. A server, comprising:
an interface;
a memory on which one or more programs are stored; and
one or more processors operably coupled to the interface and the memory, wherein the one or more processors function to:
determine whether a quantity of an item stored in an unmanned store changes;
update a user state information table based on item change information of the item stored in the unmanned store and user behavior information of a user in the unmanned store in response to determining that the quantity of the item stored in the unmanned store changes;
determine whether the user in the unmanned store has an item passing behavior; and
update the user state information table based on the user behavior information of the user in the unmanned store in response to determining that the user in the unmanned store has the item passing behavior.

17. A computer-readable medium on which a program is stored, wherein the program, when being executed by one or more processors, causes the one or more processors to:
determine whether a quantity of an item stored in an unmanned store changes;
update a user state information table based on item change information of the item stored in the unmanned store and user behavior information of a user in the unmanned store in response to determining that the quantity of the item stored in the unmanned store changes;
determine whether the user in the unmanned store has an item passing behavior; and
update the user state information table based on the user behavior information of the user in the unmanned store in response to determining that the user in the unmanned store has the item passing behavior.
